(19) United States
(12) Patent Application Publication
(10) Pub. No.: US 2007/0046586 A1
(43) Pub. Date: Mar. 1, 2007

(54) Plasma display apparatus, method of driving plasma display apparatus and address driving integrated circuit module

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/512,160

(22) Filed: Aug. 30, 2006

(30) Foreign Application Priority Data
Aug. 31, 2005 (KR) 10-2005-0080902

(51) Int. Cl. G09G 3/28

(52) U.S. Cl. 345/68

(57) ABSTRACT

A plasma display apparatus, a method of driving the plasma display apparatus and an address driving integrated circuit module are disclosed. The plasma display apparatus includes a panel capacitor, an external capacitor, an external inductor and an address driving integrated circuit module. The external capacitor supplies a charging voltage to the panel capacitor and recovers a discharging voltage from the panel capacitor. The external inductor and the panel capacitor form a resonance circuit. The address driving integrated circuit module is connected between the external inductor and the panel capacitor. The address driving integrated circuit module supplies a charging voltage to the panel capacitor, recovers a discharging voltage from the panel capacitor and supplies an address voltage and a ground level voltage.

This Nonprovisional application claims priority under 35 U.S.C. §119(a) on Patent Application No. 10-2005-0080902 filed in Korea on Aug. 31, 2005 the entire contents of which are hereby incorporated by reference.

### BACKGROUND

1. Field

This document relates to a display apparatus, and more particularly, to a plasma display apparatus, a method of driving the plasma display apparatus, and an address driving integrated circuit module.

2. Description of the Related Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs form unit discharge cell or discharge cells. Each of the discharge cells is filled with an inert gas containing a main discharge gas such as neon (Ne), helium (He) and a mixture of Ne and He, and a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultra-violet rays, which thereby cause phosphors formed between the barrier ribs to emit light, thus displaying an image. Since the plasma display panel can be manufactured to be thin and light, it has attracted attention as a next generation display device.

FIG. 1 is an exploded perspective view of the structure of a plasma display panel of a general plasma display apparatus.

Referring to FIG. 1, each discharge cell comprises a scan/sustain electrode 2Y and a common sustain electrode 2Z formed on a front substrate I and an address electrode 2A formed on a rear substrate 9.

The scan/sustain electrode 2Y and the common sustain electrode 2Z are generally made of an indium-tin-oxide (ITO) material. A bus electrode 3 made of a metal such as Cr is formed on the scan/sustain electrode 2Y and the common sustain electrode 2Z to reduce a voltage drop caused by a high resistance of the ITO material.

On the front substrate I on which the scan/sustain electrode 2Y and the common sustain electrode 2Z are formed in parallel, an upper dielectric layer 4 and a protective layer 5 are formed. The protective layer 5 is generally made of MgO to prevent a damage to the upper dielectric layer 4 caused by sputtering generated when generating a plasma discharge and to increase a secondary electron emission coefficient.

On the rear substrate 9 on which the address electrode 2A is formed, a lower dielectric layer 8 and a barrier rib 6 are formed. A phosphor 7 is coated on the surfaces of the lower dielectric layer 8 and the barrier rib 6.

The address electrode 2A is formed in perpendicular to the scan/sustain electrode 2Y and the common sustain electrode 2Z. The barrier rib 6 is formed in parallel to the address electrode 2A to prevent ultraviolet rays and visible light generated when generating the plasma discharge from leaking into an adjacent discharge cell.

The phosphor 7 is excited by the ultraviolet rays generated when generating the plasma discharge, and then generates at least one of red (R) visible light, green (G) visible light or blue (B) visible light. A discharge space formed by the front substrate 1, the rear substrate 9 and the barrier rib 6 is filled with a penning gas of Ne and Xe, and the like, for a gas discharge.

FIG. 2 is a plane view of the disposition structure of each of an electrode line and a discharge cell of a plasma display panel of a general plasma display apparatus.

Referring to FIG. 2, a general plasma display apparatus comprises a plasma display panel 21, a scan/sustain driver 22, a common sustain driver 23, an address driver 24 and a control circuit 25. In the plasma display panel 21, m×n discharge cells 20 are disposed in a matrix type in which the m×n discharge cells 20 each are connected to scan/sustain electrode lines Y1 to Ym, common sustain electrode lines Z1 to Zm and address electrode lines X1 to Xn. The scan/sustain driver 22 drives the scan/sustain electrode lines Y1 to Ym. The common sustain driver 23 drives the common sustain electrode lines Z1 to Zm. The address driver 24 drives the address electrode lines X1 to Xn. The control circuit 25 supplies a driving signal to each of the drivers 22, 23 and 24 based on display data D, a horizontal synchronization signal, a vertical synchronization signal, a clock signal, and the like, which are input from the outside.

The scan/sustain driver 22 sequentially supplies a reset pulse for uniformalizing initialization states of all the discharge cells, a scan pulse (or address pulse) for selecting cells to be discharged, and a sustain pulse for representing gray scale in accordance with the number of discharges to the scan/sustain electrode lines Y1 to Ym, thereby sequentially scanning the discharge cells 20 in line unit and maintaining a discharge in each of the m×n discharge cells 20.

The common sustain driver 23 supplies a sustain pulse to all the common sustain electrode lines Z1 to Zm, thereby generating a sustain discharge in the selected discharge cell. The scan/sustain driver 22 and the common sustain driver 23 alternately supply the sustain pulse.

The address driver 24 supplies a scan pulse synchronized with the scan pulse supplied to the scan/sustain electrode lines Y1 to Ym to the address electrode lines X1 to Xn, thereby selecting cells to be discharged.

The plasma display panel thus driven requires a high voltage of several hundreds of volts in generating an address discharge and the sustain discharge.

Accordingly, it is necessary to reduce a driving voltage. For this, each of the scan/sustain driver 22 and the common sustain driver 23 generally adopts an energy recovery circuit. The energy recovery circuit recovers charges charged to the scan/sustain electrode lines and the common sustain electrode lines and reuse the recovered charges in a next discharge.

Recently, the address driver 24 adopts an energy recovery circuit for recovering charges charged to the address electrode lines and for reusing the recovered charges in a next discharge. As a result, driving efficiency of a data integrated circuit (IC) increases. The address driver 24 comprising the energy recovery circuit is illustrated in FIG. 3

FIG. 3 schematically illustrates the configuration of an address driver comprising an energy recovery circuit in a general plasma display apparatus.

Referring to FIG. 3, an address driver of a general plasma display apparatus comprises an energy recovery circuit 31, a data IC 30, a third switch S3 and a fourth switch S4. The data IC 30 is directly connected to address electrode lines and is configured in the form of a monolithic integrated circuit. The third and fourth switches S3 and S4 perform switching operations in response to a control signal supplied during an address period to supply an address voltage Va and a ground level voltage GND to the data IC 30.

Although the switches are simply illustrated in the form of a switch in the attached drawings, the switches illustrated in the attached drawings indicate a transistor comprising a body diode, unless otherwise defined.

The data IC 30 is configured in a push-pull form, and is connected to the third and fourth switches S3 and S4 and the energy recovery circuit 31 through a power source terminal Vdd. The data IC 30 comprises fifth and sixth switches QH and QL for outputting the address voltage Va or the ground level voltage GND supplied through the power source terminal Vdd by power suppliers (not shown). The output of the data IC 30 is connected to the address electrode line.

The energy recovery circuit 31 comprises an inductor L, first and second switches S1 and S2, and first and second diodes D1 and D2. One terminal of the inductor L is connected to the data IC 30 and the third and fourth switches S3 and S4. The first and second switches S1 and S2 are connected in parallel between one terminal of an energy recovery capacitor Cs and the other terminal of the inductor L. The first and second diodes D1 and D2 prevent an inverse current. A panel capacitor Cp indicates equivalent capacitance formed between the structures of a plasma display panel such as the address electrode lines.

Operations of the energy recovery circuit 31 during the address period will be described below.

Suppose that a charge voltage Vp between the address electrodes (i.e., the charge voltage Vp to the panel capacitor Cp) is equal to 0V, and a charge voltage to the energy recovery capacitor Cs is equal to Va/2.

When the selection of a cell to be discharged does not occur, the fifth switch QH remains in a turn-off state. When the selection of a cell to be discharged occurs, the first switch Q1 and the fifth switch QH are turned on.

When the first switch Q1 and the fifth switch QH are turned on, a charging path passing through the energy recovery capacitor Cs, the first switch Q1, the first diode D1, the inductor L, the fifth switch QH and the panel capacitor Cp is formed.

The inductor L and the panel capacitor Cp form a serial resonance circuit and a charge voltage to the energy recovery capacitor Cs is equal to a voltage of Va/2. Accordingly, an output voltage to the panel capacitor Cp is two times (i.e., the address voltage Va) the charge voltage to the energy recovery capacitor Cs through charge/discharge operations of the inductor L of the serial resonance circuit.

At this time, the first switch Q1 is turned off and the third switch Q3 is turned on such that the address voltage Va is supplied to the panel capacitor Cp.

The address voltage Va supplied to the address electrode for a predetermined period of time prevents the voltage Vp of the panel capacitor Cp from falling to a voltage equal to or less than the address voltage Va for the predetermined period of time, thereby generating normally an address discharge. After generating the address discharge, the third switch S3 is turned off and, at the same time, the second switch S2 is turned on.

When the second switch S2 is turned on, a discharging path passing through the data IC 30, the inductor L, the second diode D2, the second switch S2 and the energy recovery capacitor Cs is formed. Accordingly, the voltage Vp of the panel capacitor Cp falls and, at the same time, the energy recovery capacitor Cs is charged up to a voltage of Va/2.

After the charge voltage to the energy recovery capacitor Cs is equal to Va/2, the second switch S2 is turned off and, at the same time, the fourth switch S4 is turned on.

When the fourth switch S4 is turned on, the voltage Vp of the panel capacitor Cp is maintained at a ground level voltage. An address pulse practically supplied to the address electrode occurs in synchronization with a scan pulse supplied to a scan/sustain driver. Accordingly, the energy recovery circuit 31 reduces power consumption during the address period, thereby increasing the driving efficiency of the data IC 30.

As described above, the address driver of the general plasma display apparatus comprises the energy recovery circuit 31 installed to the outside of the data IC 30 to drive the data IC 30. Further, the energy recovery circuit 31 performs the energy recovery operation and the energy supply operation through the power source terminal Vdd of the data IC 30.

However, since the address driver of the general plasma display apparatus comprises the energy recovery circuit installed to the outside of the data IC, the energy recovery circuit has the complicated configuration and a large number of elements. Accordingly, heat generation and power consumption of the energy recovery circuit increase. Further, since the energy recovery circuit comprises the inductor, it is difficult to configure the address driver in the form of a monolithic integrated circuit.

### SUMMARY

Embodiments provide a plasma display apparatus capable of improving driving efficiency and reducing heat generation and power consumption by reducing the total number of elements.

In an aspect, there is provided an address driving integrated circuit module of a plasma display apparatus comprising a first power source input terminal for receiving an address voltage, a second power source input terminal for receiving a ground level voltage, a connection terminal connected to an external inductor, and an output terminal for outputting a voltage input to the first power source input terminal and the second power source input terminal, for outputting a pulse rising to the address voltage through resonance between the external inductor and a panel capacitor, and for outputting a pulse falling from the address voltage.

In another aspect, there is provided a plasma display apparatus comprising a panel capacitor equivalently formed in a discharge cell, an external capacitor for supplying a charging voltage to the panel capacitor and for recovering a discharging voltage from the panel capacitor, an external inductor for forming the resonance circuit, and an address driving integrated circuit module, connected between the external inductor and the panel capacitor, for supplying a charging voltage to the panel capacitor, for recovering a discharging voltage from the panel capacitor and for supplying an address voltage and a ground level voltage.

In still another aspect, there is provided a method of driving a plasma display apparatus using an address driving integrated circuit module comprising a first power source input terminal for receiving an address voltage, a second power source input terminal for receiving a ground level voltage, a connection terminal connected to an external inductor, and an output terminal for outputting a voltage input to the first power source input terminal and the second power source input terminal, for outputting a pulse rising to the address voltage through resonance between the external inductor and a panel capacitor and for outputting a pulse falling from the address voltage, comprising outputting the pulse rising to the address voltage to an address electrode through the output terminal, outputting the pulse failing from the address voltage to the address electrode through the output terminal, outputting the address voltage input through the first power source input terminal to the address electrode through the output terminal, and outputting the ground level voltage input through the second power source input terminal to the address electrode through the output terminal.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is an exploded perspective view of the structure of a plasma display panel of a general plasma display apparatus;

FIG. 2 is a plane view of the disposition structure of each of an electrode line and a discharge cell of a plasma display panel of a general plasma display apparatus;

FIG. 3 schematically illustrates the configuration of an address driver comprising an energy recovery circuit in a general plasma display apparatus.

FIG. 4 illustrates the configuration of an address driving integrated circuit module of a plasma display apparatus according to a first embodiment;

FIG. 5 illustrates on/off timing of switches during an address period and an output waveform of a panel capacitor in response to the on/off timing of the switches using the address driving integrated circuit module of the plasma display apparatus according to the first embodiment;

FIG. 6 illustrates the configuration of an address driving integrated circuit module of a plasma display apparatus according to a second embodiment;

FIG. 7 illustrates on/off timing of switches during an address period and an output waveform of a panel capacitor in response to the on/off timing of the switches using the address driving integrated circuit module of the plasma display apparatus according to the second embodiment;

FIG. 8 illustrates the configuration of an address driving integrated circuit module of a plasma display apparatus according to a third embodiment; and

FIG. 9 illustrates on/off timing of switches during an address period and an output waveform of a panel capacitor in response to the on/off timing of the switches using the address driving integrated circuit module of the plasma display apparatus according to the third embodiment

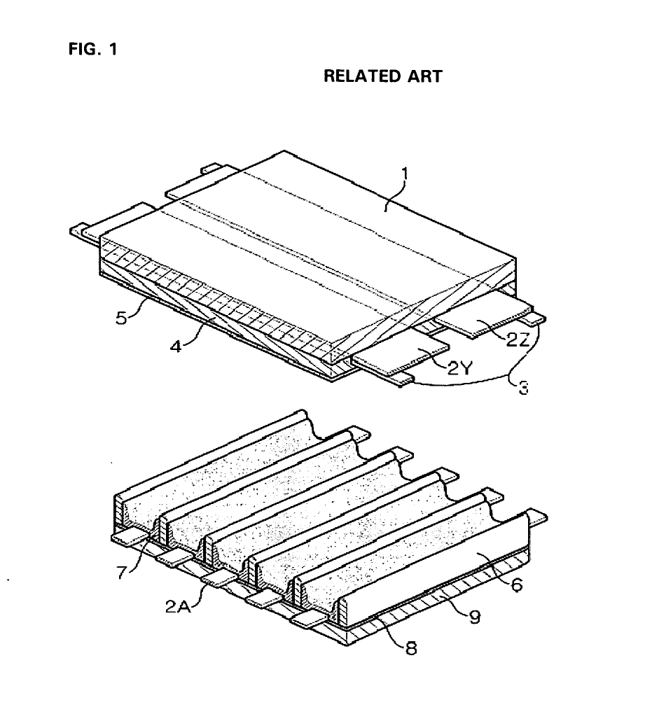

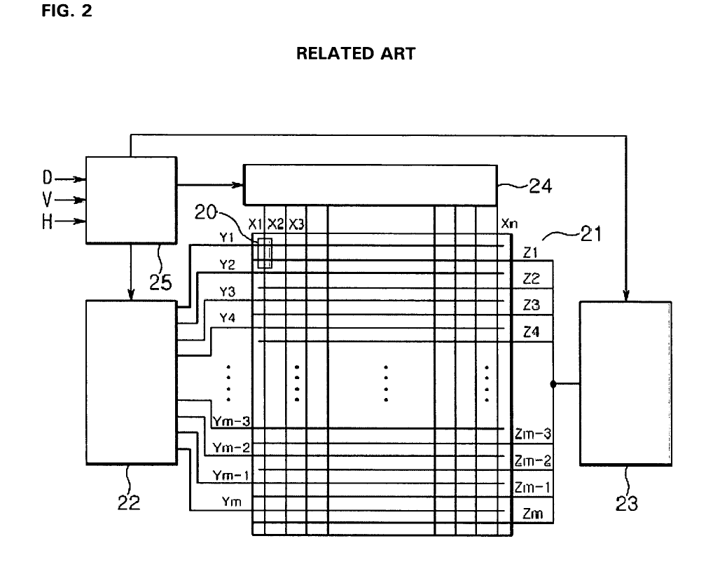

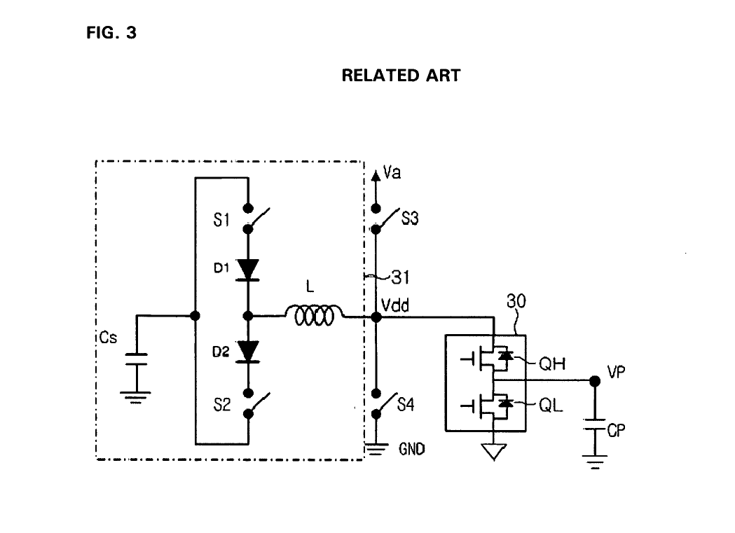

### DETAILED DESCRIPTION OF PREFERRED EMBODIMENTS

Reference will now be made in detail embodiments of the invention examples of which are illustrated in the accompanying drawings.

An address driving integrated circuit module of a plasma display apparatus comprises a first power source input terminal for receiving an address voltage, a second power source input terminal for receiving a ground level voltage, a connection terminal connected to an external inductor, and an output terminal for outputting a voltage input to the first power source input terminal and the second power source input terminal, for outputting a pulse rising to the address voltage through resonance between the external inductor and a panel capacitor, and for outputting a pulse falling from the address voltage.

The address driving integrated circuit module may be formed in the form of a monolithic integrated circuit.

A plasma display apparatus comprises a panel capacitor equivalently formed in a discharge cell, an external capacitor for supplying a charging voltage to the panel capacitor and for recovering a discharging voltage from the panel capacitor, an external inductor for forming the resonance circuit, and an address driving integrated circuit module, connected between the external inductor and the panel capacitor, for supplying a charging voltage to the panel capacitor, for recovering a discharging voltage from the panel capacitor and for supplying an address voltage and a ground level voltage.

The address driving integrated circuit module may be formed in the form of a monolithic integrated circuit.

One terminal of the external inductor may be connected to the address driving integrated circuit module. The other terminal of the external inductor may be connected to one terminal of the external capacitor. The other terminal of the external capacitor may be connected to a ground level voltage.

The address driving integrated circuit module may comprise a charging/discharging controller for forming a charging path for supplying the charging voltage and a discharging path for recovering the discharging voltage through the external inductor, and a switching unit for performing a turn-on operation and a turn-off operation in response to a predetermined control signal to supply the address voltage and the ground level voltage to the panel capacitor.

The charging/discharging controller may comprise a first switch and a second switch. The charging/discharging controller may form a charging path for supplying a charge voltage of the external capacitor to the panel capacitor, and a discharging path for supplying a voltage recovered from the panel capacitor to the external capacitor.

The switching unit may comprise a third switch and a fourth switch for supplying the address voltage to the panel capacitor, and a fifth switch for supplying the ground level voltage to the panel capacitor.

The charging path may pass through the external inductor, the first switch and the fourth switch The discharging path may pass through the external inductor, the second switch and the fourth switch. The address driving integrated circuit module may comprise an output terminal connected between the fourth switch and the fifth switch.

The third switch may supply the charging voltage to the panel capacitor through the charging path, and may be then turned on. The fifth switch may recover a voltage supplied to the panel capacitor through the discharging path, and may be then turned on.

The charging path may pass through the external inductor, the first switch and the fourth switch. The discharging path may pass through the external inductor and the second switch. The address driving integrated circuit module may comprise an output terminal connected between the fourth switch and the fifth switch.

The third switch may supply the charging voltage to the panel capacitor through the charging path, and may be then turned on. The fifth switch may recover a voltage supplied to the panel capacitor through the discharging path, and may be then turned on.

The charging/discharging controller may comprise a first switch and a second switch. The charging path for supplying a charge voltage of the external capacitor to the panel capacitor may be the same as the discharging path for supplying a voltage recovered from the panel capacitor to the external capacitor.

The first switch and the second switch each may comprise a body diode. A cathode terminal of the body diode of the first switch and a cathode terminal of the body diode of the second switch may be disposed to oppose to each other.

The switching unit may comprise a third switch for supplying the address voltage to the panel capacitor, and a fourth switch for supplying the ground level voltage to the panel capacitor. The address driving integrated circuit module may comprise an output terminal connected between the third switch and the fourth switch.

The third switch may supply the charging voltage to the panel capacitor through the charging path, and may be then turned on. The fourth switch may recover a voltage supplied to the panel capacitor through the discharging path, and may be then turned on.

A method of driving a plasma display apparatus using an address driving integrated circuit module comprising a first power source input terminal for receiving an address voltage, a second power source input terminal for receiving a ground level voltage, a connection terminal connected to an external inductor, and an output terminal for outputting a voltage input to the first power source input terminal and the second power source input terminal, for outputting a pulse rising to the address voltage through resonance between the external inductor and a panel capacitor and for outputting a pulse falling from the address voltage, comprises outputting the pulse rising to the address voltage to an address electrode through the output terminal, outputting the pulse falling from the address voltage to the address electrode through the output terminal, outputting the address voltage input through the first power source input terminal to the address electrode through the output terminal, and outputting the ground level voltage input through the second power source input terminal to the address electrode through the output terminal.

The pulse rising to the address voltage and the pulse falling from the address voltage may be input through the connection terminal.

Hereinafter, exemplary embodiments of the present invention will be described in detail with reference to the attached drawings.

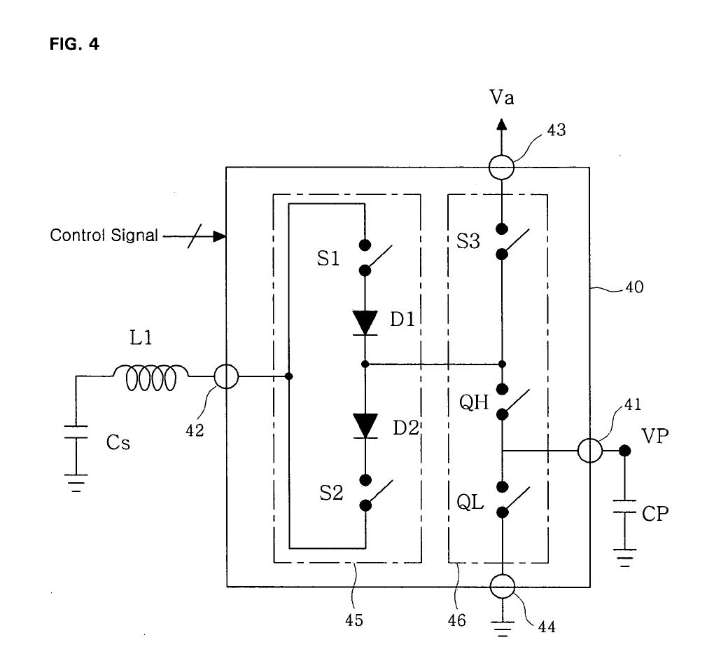

FIG. 4 illustrates the configuration of an address driving integrated circuit module of a plasma display apparatus according to a first embodiment

Referring to FIG. 4, the address driving integrated circuit module 40 of the plasma display apparatus according to the first embodiment comprises a charging/discharging controller 45 and a switching unit 46. The charging/discharging controller 45 comprises first and second switches S1 and S2 which are connected in parallel, and first and second diodes D1 and D2 for preventing an inverse current between the first and second switches S1 and S2. The switching unit 46 comprises third and fourth switches S3 and QH which are connected between the first and second diodes D1 and D2 of the charging/discharging controller 45 and supply an address voltage Va to address electrode lines, and a fifth switch QL which is connected to the fourth switch QH and supplies a ground level voltage GND to the address electrode lines. The fourth switch QH of the address driving integrated circuit module 40 further functions to form a charging path and a discharging path of a panel capacitor Cp.

The address driving integrated circuit module 40 comprises an output terminal 41, a connection terminal 42, a first power source input terminal 43 and a second power source input terminal 44. The output terminal 41 is connected between the fourth and fifth switches QH and QL, and selectively supplies the address voltage Va or the ground level voltage GND to the address electrode lines. The connection terminal 42 connects the charging/discharging controller 45 to an external energy recovery circuit comprising an external energy recovery capacitor Cs and an external inductor L1 which are connected in series. The first power source input terminal 43 and the second power source input terminal 44 is connected to a power source supplier (not shown) for supplying the address voltage Va and the ground level voltage GND during the address period.

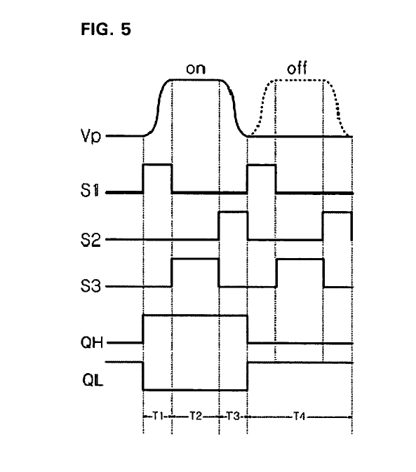

FIG. 5 illustrates On/Off timing of switches and an output waveform of a panel capacitor during an address period using the address driving integrated circuit module of the plasma display apparatus according to the first embodiment

FIGS. 4 and 5 illustrate an operation of the address driving integrated circuit module 40 during the address period.

Suppose that before a period T1, a charge voltage between address electrodes (i.e., a charge voltage Vp to the panel capacitor Cp) is equal to 0V, and a charge voltage to the external energy recovery capacitor Cs is equal to Va/2.

During the period T1, the first switch S1 and the fourth switch QH are turned on and the fifth switch QL are turned off. When the selection of a cell to be discharged does not occur in the above switching state, the fourth switch QH remains in a turn-on state, and the fifth switch QL remains in a turn-off state.

When the first switch S1 and the fourth switch QH are turned on and the fifth switch QL are turned off, a charging path passing through the external energy recovery capacitor Cs, the external inductor L1, the first switch S1, the first diode D1, the fourth switch QH and the output terminal 41 is formed.

The external inductor L1 and the panel capacitor Cp form a serial resonance circuit, and a charge voltage to the external energy recovery capacitor Cs is equal to Va/2. Accordingly, an output voltage to the panel capacitor Cp is two times (i.e., the address voltage Va) the charge voltage to the external energy recovery capacitor Cs through charge/discharge operations of the external inductor L1 of the serial resonance circuit.

At this time, the third switch Q3 is turned on and, at the same time, the first switch Q1 is turned off such that the address voltage Va is supplied to the panel capacitor Cp. The address voltage Va supplied to the panel capacitor Cp prevents the voltage Vp of the panel capacitor Cp from falling a voltage equal to or less than the address voltage Va, thereby generating normally an address discharge.

After maintaining the voltage Vp of the panel capacitor Cp at the address voltage Va during a period T2, the third switch Q3 is turned off and, at the same time, the second switch Q2 is turned on during a period T3.

When the second switch S2 is turned on, a discharging path passing through the output terminal 41, the second diode D2, the second switch S2, the external inductor L1 and the external energy recovery capacitor Cs is formed. Accordingly, the voltage Vp of the panel capacitor Cp falls and, at the same time, the external energy recovery capacitor Cs is charged up to a voltage of Va/2.

After the charge voltage to the external energy recovery capacitor Cs is equal to Va/2, the second switch S2 and the fourth switch QH are turned off and, at the same time, the fifth switch QL is turned on during a period T4 and after the period T4.

When the fifth switch QL is turned on, the voltage Vp of the panel capacitor Cp is maintained at the ground level voltage GND input from the second power source input terminal 44.

The energy recovery circuit in the plasma display apparatus of the above-described configuration according to the first embodiment is different from the related art energy recovery circuit in a connection location of the inductor. Further, the address driving integrated circuit module 40 according to the first embodiment function as the related art data IC using the fourth and fifth switches QH and QL.

In other words, the address driving integrated circuit module 40 of the plasma display apparatus according to the first embodiment is designed as a module for integrating a portion of the related art energy recovery circuit and the related art data IC, and the fifth switch QL of the address driving integrated circuit module 40 functions as not only the sixth switch QL of the related art data IC 30 but also the related art fourth switch S4. Accordingly, the number of elements in the plasma display apparatus according to the first embodiment decreases such that the driving efficiency of the plasma display apparatus is improved and the power consumption caused by the heat generation decreases.

Further, since the external energy recovery capacitor Cs and the external inductor L1 of the energy recovery circuit are disposed to the outside of the address driving integrated circuit module 40, the address driving integrated circuit module 40 comprises only active devices. Accordingly, the address driving integrated circuit module 40 provides the circuit configuration suitable for configuring a monolithic integrated circuit.

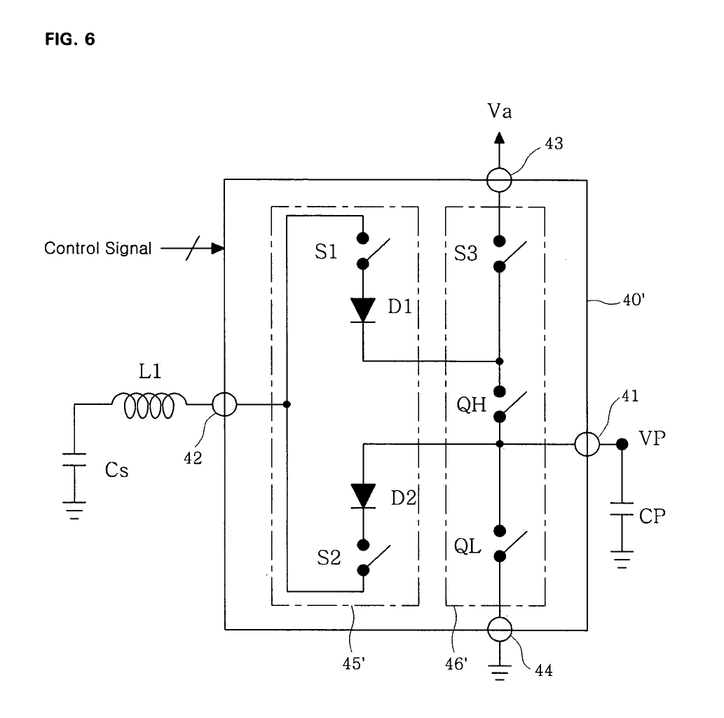

FIG. 6 illustrates the configuration of an address driving integrated circuit module of a plasma display apparatus according to a second embodiment.

The address driving integrated circuit module of the plasma display apparatus according to the second embodiment of FIG. 6 is an application of the address driving integrated circuit module of the plasma display apparatus according to the first embodiment of FIG. 4. Therefore, identical or equivalent components of the address driving integrated circuit module of FIG. 6 and the address driving integrated circuit module of FIG. 4 are designated with the same reference numerals.

Referring to FIG. 6, the address driving integrated circuit module 40′ of the plasma display apparatus according to the second embodiment has the same configuration as the address driving integrated circuit module 40 of the plasma display apparatus according to the first embodiment except the following differences. The differences are that a first diode D1 and a second diode D2 of a charging/discharging controller 45′ are not directly connected to each other, one terminal of a fourth switch QH of a switching unit 46′ is connected to a third switch S3 of the switching unit 46′ and the first diode D1 of the charging/discharging controller 45′, and the other terminal of the fourth switch QH is connected to the second diode D2 of the charging/discharging controller 45′, a fifth switch QL of the switching unit 46′ and an output terminal 41.

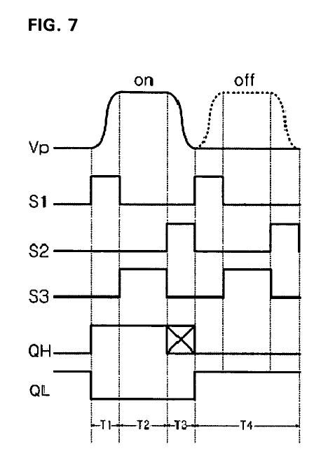

FIG. 7 illustrates on/off timing of switches during an address period and an output waveform of a panel capacitor in response to the on/off tiring of the switches using the address driving integrated circuit module of the plasma display apparatus according to the second embodiment

Referring to FIGS. 6 and 7, an operation of the address driving integrated circuit module 40′ during the address period in the plasma display apparatus according to the second embodiment is almost same as the operation of the address driving integrated circuit module 40 during the address period in the plasma display apparatus according to the first embodiment. However, during a period T3 when a second switch S2 is turned on and a third switch S3 is turned off, a discharging path formed by the charging/discharging controller 45′ may not pass through a fourth switch QH. Accordingly, the fourth switch QH may be turned on or off during the period T3.

In other words, in the address driving integrated circuit module 40′ of the plasma display apparatus according to the second embodiment, a charging path and the discharging path formed by the charging/discharging controller 45′ are divided based on the fourth switch QH.

When recovering energy from an address electrode and then supplying the recovered energy to an energy recovery circuit, the discharging path does not pass through the fourth switch QH and the discharging path passing through the second diode D2 and the second switch S2 is formed. Accordingly, the address driving integrated circuit module 40′ according to the second embodiment further increases the driving efficiency and further decreases power consumption caused by the heat generation in comparison with the address driving integrated circuit module 40 according to the first embodiment of FIG. 4.

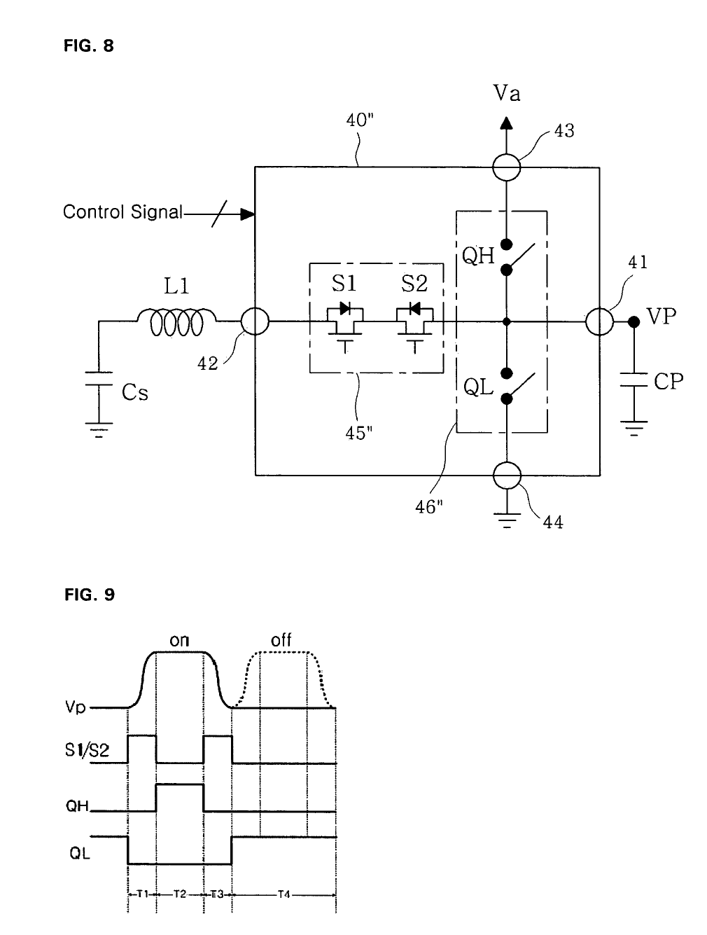

FIG. 8 illustrates the configuration of an address driving integrated circuit module of a plasma display apparatus according to a third embodiment. The configuration of the address driving integrated circuit module of FIG. 8 is simpler than the configuration of the address driving integrated circuit modules of FIGS. 4 and 6. Identical or equivalent components of the address driving integrated circuit module of FIG. 8 and the address driving integrated circuit module of FIG. 4 are designated with the same reference numerals.

Referring to FIG. 8, a charging/discharging controller 45″ of the address driving integrated circuit module 40″ comprises a first switch S1 and a second switch S2 connected to each other in series. In other words, diodes are omitted in the charging/discharging controller 45″. A switching unit 46″ comprising a third switch QH and a fourth switch QL directly supplies an address voltage Va and a ground level voltage GND.

The address driving integrated circuit module 40″ according to the third embodiment corresponds to the circuit configuration using a high impedance state in which an On-signal and an Off-signal are not supplied to the data IC during the charging and discharging periods (i.e., periods T1 and T3) of the related art energy recovery circuit.

FIG. 9 illustrates on/off timing of switches during an address period and an output waveform of a panel capacitor in response to the on/off timing of the switches using the address driving integrated circuit module of the plasma display apparatus according to the third embodiment

The following is a detailed description of an operation of the address driving integrated circuit module 40″ of the plasma display apparatus according to the third embodiment during the address period, with reference to FIGS. 8 and 9.

During the periods TI and T3 when a charging path and a discharging path are formed through the charging/discharging controller 45″, an On-signal as a control signal is applied to the first switch S1 and the second switch S2 connected in series and, at the same time, an Off-signal is applied to the third switch QH, thereby obtaining output equal to the output obtained by the address driving integrated circuit modules illustrated in FIGS. 4 and 6.

The number of switches in the address driving integrated circuit module 40″ illustrated in FIG. 8 is less than the number of switches in the address driving integrated circuit modules 40 and 40′ illustrated in FIGS. 4 and 6. Accordingly, the address driving integrated circuit module 40″ illustrated in FIG. 8 further increases the driving efficiency and further reduces power consumption caused by the heat generation.

In the plasma display apparatus according to the embodiments, the external inductor L1 is connected between the connection terminal 42 of the address driving integrated circuit module and the external energy recovery capacitor Cs. However, the plasma display apparatus according to the embodiments are not limited thereto. Many additional implementations are possible. For example, in the same way as the related aft, the plasma display apparatus according to the embodiments may comprise other terminal(s) so that the external inductor L1 may be connected between the charging/discharging controller and the switching unit of the address driving integrated circuit module.

For example, only the external energy recovery capacitor Cs is connected to the connection terminal 42. In a case of the address driving integrated circuit module 40 illustrated in FIG. 4, two separately provided terminals are connected to the external inductor L1. Accordingly, the external inductor L1 may be connected to the third switch S3, the fourth switch QH and the charging/discharging controller 45.

Further, in a case of the address driving integrated circuit module 40′ illustrated in FIG. 6, three separately provided terminals are connected to the external inductor L1. Accordingly, the external inductor L1 may be connected to the third switch S3, the fourth switch QH and the first diode D1 and, at the same time, another external inductor may be connected between the second diode D2 and the output terminal 41.

Further, in a case of the address driving integrated circuit module 40″ illustrated in FIG. 8, the external inductor L1 may be connected to the second switch S2 and the output terminal 41 using a separately provided terminal.

Although the number of terminals in the above-described address driving integrated circuit modules increases, the technical effects to be achieved in the additional implementation is equal to the technical effects to be achieved in the above embodiments.

Many alternatives, modifications, and variations of the address driving integrated circuit module of the plasma display apparatus according to the embodiments is possible without departing from the spirit and scope of those skilled in the art. For example, the switch according to the embodiments may be substituted for another switch known to those skilled in the art other than a field effect transistor (FET), if necessary.

Since a portion of the energy recovery circuit and the data IC are integrated into one circuit in the plasma display apparatus according to the embodiments, the total number of elements decreases and the heat generation of the address driving integrated circuit module decreases by a decrease in the total number of elements. Accordingly, the plasma display apparatus having the simple circuit configuration and the improved driving efficiency is achieved.

Further, since the inductor installed inside the energy recovery circuit is disposed to the outside of the address driving integrated circuit module, the address driving integrated circuit module comprising only the active devices can be configured. Accordingly, the address driving integrated circuit module can provide the circuit configuration suitable for configuring a monolithic integrated circuit.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. An address driving integrated circuit module of a plasma display apparatus comprising:
a first power source input terminal for receiving an address voltage;
a second power source input terminal for receiving a ground level voltage;
a connection terminal connected to an external inductor; and
an output terminal for outputting a voltage input to the first power source input terminal and the second power source input terminal, for outputting a pulse rising to the address voltage through resonance between the external inductor and a panel capacitor, and for outputting a pulse falling from the address voltage.

2. The address driving integrated circuit module of the plasma display apparatus of claim 1, wherein the address driving integrated circuit module is formed in the form of a monolithic integrated circuit.

3. A plasma display apparatus comprising:
a panel capacitor equivalently formed in a discharge cell;
an external capacitor for supplying a charging voltage to the panel capacitor and for recovering a discharging voltage from the panel capacitor;
an external inductor for forming the resonance circuit; and
an address driving integrated circuit module, connected between the external inductor and the panel capacitor, for supplying a charging voltage to the panel capacitor, for recovering a discharging voltage from the panel capacitor and for supplying an address voltage and a ground level voltage.

4. The plasma display apparatus of claim 3, wherein the address driving integrated circuit module is formed in the form of a monolithic integrated circuit.

5. The plasma display apparatus of claim 4, wherein one terminal of the external inductor is connected to the address driving integrated circuit module, the other terminal of the external inductor is connected to one terminal of the external capacitor, and the other terminal of the external capacitor is connected to a ground level voltage.

6. The plasma display apparatus of claim 4, wherein the address driving integrated circuit module comprises a charging/discharging controller for forming a charging path for supplying the charging voltage and a discharging path for recovering the discharging voltage through the external inductor, and a switching unit for performing a turn-on operation and a turn-off operation in response to a predetermined control signal to supply the address voltage and the ground level voltage to the panel capacitor.

7. The plasma display apparatus of claim 6, wherein the charging/discharging controller comprises a first switch and a second switch, and
the charging/discharging controller forms a charging path for supplying a charge voltage of the external capacitor to the panel capacitor, and a discharging path for supplying a voltage recovered from the panel capacitor to the external capacitor.

8. The plasma display apparatus of claim 7, wherein the switching unit comprises a third switch and a fourth switch for supplying the address voltage to the panel capacitor, and a fifth switch for supplying the ground level voltage to the panel capacitor.

9. The plasma display apparatus of claim 8, wherein the charging path passes through the external inductor, the first switch and the fourth switch,
the discharging path passes through the external inductor, the second switch and the fourth switch, and
the address driving integrated circuit module comprises an output terminal connected between the fourth switch and the fifth switch.

10. The plasma display apparatus of claim 9, wherein the third switch supplies the charging voltage to the panel capacitor through the charging path, and is then turned on, and
the fifth switch recovers a voltage supplied to the panel capacitor through the discharging path, and is then turned on.

11. The plasma display apparatus of claim 8, wherein the charging path passes through the external inductor, the first switch and the fourth switch,
the discharging path passes through the external inductor and the second switch, and
the address driving integrated circuit module comprises an output terminal connected between the fourth switch and the fifth switch.

12. The plasma display apparatus of claim 11, wherein the third switch supplies the charging voltage to the panel capacitor through the charging path, and is then turned on, and
the fifth switch recovers a voltage supplied to the panel capacitor through the discharging path, and is then turned on.

13. The plasma display apparatus of claim 6, wherein the charging/discharging controller comprises a first switch and a second switch, and
the charging path for supplying a charge voltage of the external capacitor to the panel capacitor is the same as the discharging path for supplying a voltage recovered from the panel capacitor to the external capacitor.

14. The plasma display apparatus of claim 7, wherein the first switch and the second switch each comprise a body diode, and
a cathode terminal of the body diode of the first switch and a cathode terminal of the body diode of the second switch are disposed to oppose to each other.

15. The plasma display apparatus of claim 13, wherein the switching unit comprises a third switch for supplying the address voltage to the panel capacitor, and a fourth switch for supplying the ground level voltage to the panel capacitor, and
the address driving integrated circuit module comprises an output terminal connected between the third switch and the fourth switch.

16. The plasma display apparatus of claim 15, wherein the third switch supplies the charging voltage to the panel capacitor through the charging path, and is then turned on, and
the fourth switch recovers a voltage supplied to the panel capacitor through the discharging path, and is then turned on.

17. A method of driving a plasma display apparatus using an address driving integrated circuit module comprising a first power source input terminal for receiving an address voltage, a second power source input terminal for receiving a ground level voltage, a connection terminal connected to an external inductor, and an output terminal for outputting a voltage input to the first power source input terminal and the second power source input terminal, for outputting a pulse rising to the address voltage through resonance between the external inductor and a panel capacitor and for outputting a pulse falling from the address voltage, comprising:
outputting the pulse rising to the address voltage to an address electrode through the output terminal;
outputting the pulse falling from the address voltage to the address electrode through the output terminal;
outputting the address voltage input through the first power source input terminal to the address electrode through the output terminal; and
outputting the ground level voltage input through the second power source input terminal to the address electrode through the output terminal.

18. The method of claim 17, wherein the pulse rising to the address voltage and the pulse falling from the address voltage are input through the connection terminal.
